(19) United States
(12) Patent Application Publication
(10) Pub. No.: US 2015/0370443 A1
(43) Pub. Date: Dec. 24, 2015

(54) SYSTEM AND METHOD FOR COMBINING TOUCH AND GESTURE IN A THREE DIMENSIONAL USER INTERFACE

(71) Applicant: INUITIVE LTD., Ra'anana (IL)

(72) Inventor: David BEN-BASSAT, Ganei Tikva (IL)

(21) Appl. No.: 14/765,578

(22) PCT Filed: Feb. 12, 2014
(86) PCT No.: PCT/IL2014/050150

§ 371 Date: Aug. 4, 2015

Related U.S. Application Data
(60) Provisional application No. 61/763,573, filed on Feb. 12, 2013.

(51) Int. Cl. G06F 3/0488; G06F 3/041; G06F 3/01

(52) U.S. Cl. CPC G06F 3/0488; G06F 3/017; G06F 3/041; G06F 2203/04104

(57) ABSTRACT

A system and a method that implement a user interface are provided herein. The system includes a touch interface, a gesture sensor and a processing element arranged to generate an interface command that corresponds to a combination of a touch detected by the touch interface and a gesture identified by the gesture sensor, wherein the correspondence determined according to specified rules. The method implements the logic of the aforementioned system.

### TECHNICAL FIELD

The present invention relates to the field of user interface, and more particularly, to combined touch and gesture user interface.

### BACKGROUND OF THE INVENTION

Touch displays support various types of controls, all of them are applicable when the user touches the screen or get at close proximity to the screen. Specifically, multi-touch displays typically support controls such as scroll, zoom in/out, pinch, click to select etc.

Gesture recognition systems also support various types of controls all applicable in the 3D volume facing the gesture sensor. Typically, gesture recognition sensors cannot be used as touch replacement for the following reasons: (i) Tracking accuracy of the gesture sensor is usually not adequate to replace touch, (ii) when a user operates in thin air, movements are not as precise and as controlled; and (iii) multi touch is hard to emulate, when there is no well-defined surface.

### SUMMARY OF THE INVENTION

Some embodiments of the present invention provides an interface system comprising a touch interface; a gesture sensor; and a processing element arranged to generate an interface command that corresponds to a combination of a touch detected by the touch interface and a gesture identified by the gesture sensor, the correspondence determined according to specified rules.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIGS. 1A-1C are high level schematic illustrations of an interface system, according to some embodiments of the invention; and

FIG. 2 is a high level flowchart illustrating an interface method, according to some embodiments of the invention.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention, in embodiments thereof, introduces a new family of gestures to control and interface a computer or personal mobile device. These gestures are based on a combination of touch screen and gesture recognition. The invention aims to expand and enhance the command and control motions used to interface with computers, laptops, tablets and mobile devices. The enhancement is based on a combination of touch technology with 3D gesture recognition and introduces in detail a family of command and control interfaces that are implemented by combining touch technology with 3D gesture recognition technology. One option, the user is operating both technologies simultaneously to get the control interface by his two hands. Another option the user is operating both technologies at sequence to get the control interface by one hand at a time hands. For example select an object on the screen by touching it and then perform a gesture to control it. It also optional to have the same controlling by two different users one use the touch screen and the other the gesture recognition.

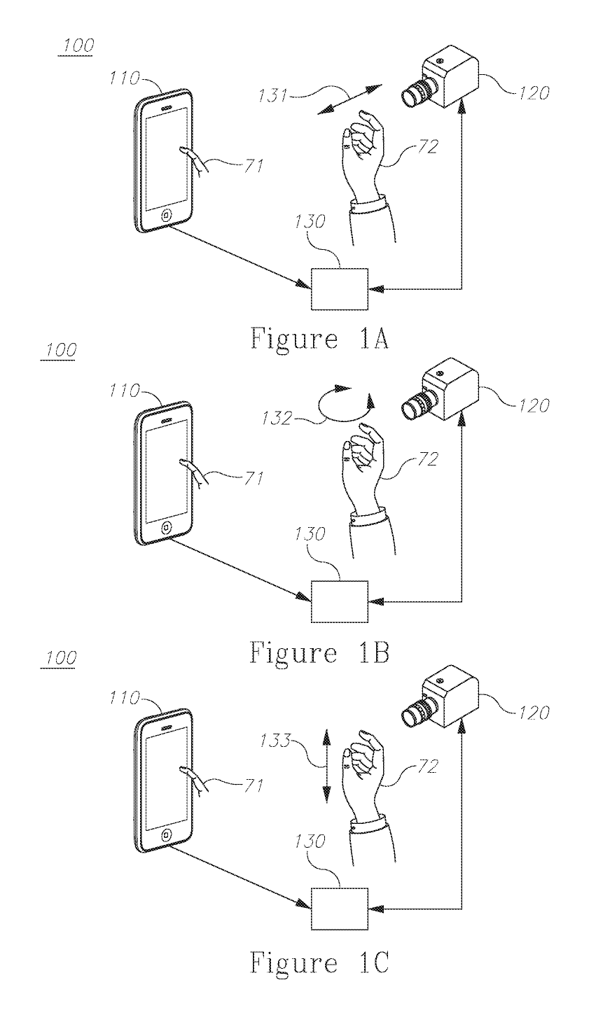

FIGS. 1A-1C are high level schematic illustrations of an interface system 100, according to some embodiments of the invention. Interface system 100 comprises a touch interface 110 (e.g. a multi-touch interface), a gesture sensor 120 (e.g. a three dimensional or a two dimensional gesture sensor) and a processing element 130 arranged to generate an interface command that corresponds to a combination of a touch detected by touch interface 110 and a gesture identified by gesture sensor 120. The processing element 130 may detect the correspondence between the touch interface detection and the gesture sensor detection. In order to enable this correspondence detection time synchronization may be needed between the two sensing devices. Such synchronization may be performed by having the same clock controlling both devices detection technique. Gesture sensor 120 may be closely coupled to touch interface 110.

The correspondence determined according to specified rules, relating e.g. gestures such as a linear movement towards or away from touch detection surface 110, a linear movement parallel to touch detection surface 110, a rotational movement, a repetition thereof or a combination thereof; with interface commands such as e.g. a zoom, an image rotation and an image twist.

Gestures may be identified e.g. with respect to touch interface 110.

As a non-limiting example, the following gestures and corresponding commands may be implemented by system 100. (i) A 3D selective zoom corresponding to one finger 71 touching a specific point on touch interface 110, while a hand 72 moves to or from (arrow 131) touch interface 110 to signify the gesture, as illustrated in FIG. 1A. The zoom may be in and out with the touch point being the reference point for zoom. (ii) An image rotation corresponding to one finger 71 touching a specific point on touch interface 110, while hand 72 rotating (arrow 132) with or without respect to touch interface 110 to signify the gesture, as illustrated in FIG. 1B. The image rotation may be carried out with respect to the touch point as the rotation pivot. (iii) A 3D twist and curl corresponding to one finger 71 touching a specific point on touch interface 110, while hand 72 moves or rotates perpendicular to or from (arrow 133) touch interface 110 to signify the gesture, as illustrated in FIG. 1C. The twist and curl may be determined with respect to the touch point being the reference point for twist. The gestures may comprise linear gestures, arc gestures and other non-linear gestures and may be carried out in different directions with respect to touch interface 110.

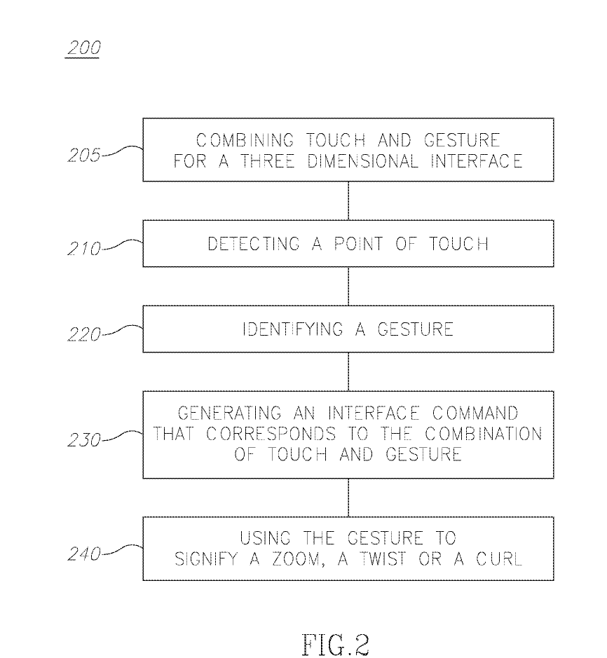

FIG. 2 is a high level flowchart illustrating an interface method 200, according to some embodiments of the invention. Interface method 200 may be implemented partially or wholly by at least one computer processor.

Interface method 200 comprises combining touch and gesture for a three dimensional interface (stage 205) by detecting a point of touch (step 210), identifying a gesture (step 220) and generating an interface command that corresponds to the combination of the detected touch and the identified gesture (step 230) the correspondence determined according to specified rules. At least one of detecting 210, identifying 220 and generating 230 is carried out by at least one computer processor. For example, the gesture may be used to signify a zoom, a twist or a curl (step 240).

Identifiable gestures in step 220 may comprise at least one of: a linear movement towards or away from a touch detection surface, a linear movement parallel or perpendicular to the touch detection surface, a rotational movement, a repetition thereof and a combination thereof. The interface commands may comprise at least one of: a zoom, an image rotation and an image twist.

Some embodiments comprise a computer program product comprising a computer readable storage medium having computer readable program embodied therewith. The computer readable program comprises computer readable program configured to generate an interface command that corresponds to a combination of a touch detected by a touch interface and a gesture identified by a gesture sensor, the correspondence determined according to specified rules. Identifiable gestures may comprise a linear movement towards or away from a touch detection surface, a linear movement perpendicular to the touch detection surface, a rotational movement, a repetition thereof and a combination thereof; and corresponding interface commands comprise a zoom, an image rotation and an image twist.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Embodiments of the invention may include features from different embodiments disclosed above, and embodiments may incorporate elements from other embodiments disclosed above. The disclosure of elements of the invention in the context of a specific embodiment is not to be taken as limiting their used in the specific embodiment alone.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system comprising:
a touch interface;
a gesture sensor; and
a processing element arranged to generate an interface command that corresponds to a combination of a touch detected by the touch interface and a gesture identified by the gesture sensor, the correspondence determined according to specified rules.

2. The system of claim 1, wherein the gesture is identified with respect to the touch interface.

3. The system of claim 1, wherein the touch interface is a multi-touch interface.

4. The system of claim 1, wherein the gesture sensor comprises at least one of a three dimensional and a two dimensional gesture sensor.

5. The system of claim 1, wherein identifiable gestures comprise at least one of: a linear movement towards or away from a touch detection surface, a linear movement parallel to the touch detection surface, a rotational movement, a repetition thereof and a combination thereof; and corresponding interface commands comprise at least one of: a zoom, an image rotation and an image twist.

6. An method comprising:
detecting a touch event;
identifying a gesture; and
generating an interface command that corresponds to a combination of the detected touch and the identified gesture, the correspondence determined according to specified rules,
wherein at least one of: the detecting, the identifying and the generating is carried out by at least one computer processor.

7. The method of claim 6, wherein identifiable gestures comprise at least one of: a linear movement towards or away from a touch detection surface, a linear movement parallel to the touch detection surface, a rotational movement, a repetition thereof and a combination thereof.

8. The method of claim 6, wherein the interface command comprises at least one of: a zoom, an image rotation and an image twist.

9. A computer program product comprising a computer readable storage medium having computer readable program embodied therewith, the computer readable program comprising computer readable program configured to generate an interface command that corresponds to a combination of a touch detected by a touch interface and a gesture identified by a gesture sensor, the correspondence determined according to specified rules.

10. The computer program product of claim 9, wherein identifiable gestures comprise at least one of: a linear movement towards or away from a touch detection surface, a linear movement perpendicular to the touch detection surface, a rotational movement, a repetition thereof and a combination thereof; and corresponding interface
